(19) United States
(12) Patent Application Publication
(10) Pub. No.: US 2005/0230305 A1
(43) Pub. Date: Oct. 20, 2005

(54) Novel method for forming a mixed matrix composite membrane using washed molecular sieve particles

(76) Inventors: Sudhir S. Kulkarni, Wilmington, DE (US); Okan Max Ekiner, Wilmington, DE (US); David J. Hasse, Bel Air, MD (US)

Correspondence Address: AIR LIQUIDE, 2700 POST OAK BOULEVARD, SUITE 1800, HOUSTON, TX, 77056, US

(21) Appl. No.: 11/091,156

(22) Filed: Mar. 28, 2005

Related U.S. Application Data
(60) Provisional application No. 60/556,855, filed on Mar. 26, 2004.

(51) Int. Cl. B01D 69/08

(52) U.S. Cl. 210/500.23; 210/500.27; 210/500.38; 264/41; 96/10; 96/4

(57) ABSTRACT

This abstract discusses producing mixed matrix composite (MMC) membranes with a good balance of permeability and selectivity. MMC membranes are particularly needed for separating fluids in oxygen/nitrogen separation processes, processes for removing carbon dioxide from hydrocarbons or nitrogen, and the separation of hydrogen from petrochemical and oil refining streams. MMC Membranes made using washed sieve material, such as washed SSZ-13 sieve material, provide surprisingly good permeability and selectivity. The method of the current invention produces a fluid separation membrane by providing a polymer and a washed molecular sieve material, then synthesizing a concentrated suspension of a solvent, the polymer, and the washed molecular sieve material. The concentrated suspension is used to form the fluid separation membrane of the desired configuration. Membranes of the current invention can be formed into hollow fiber membranes that are particularly suitable for high trans-membrane pressure applications.

### GOVERNMENT RIGHTS

The current invention was made with Government support provided by the terms of contract No. ______, awarded by the National Institute of Standards and Technology, thus the Government has certain rights in the invention.

### BACKGROUND

This invention relates to fluid separation membranes incorporating a molecular sieve material dispersed in a polymer.

The use of selectively fluid permeable membranes to separate the components of fluid mixtures is a well developed and commercially very important art. Such membranes are traditionally composed of a homogeneous, usually polymeric, composition through which the components to be separated from the mixture are able to travel at different rates under a given set of driving force conditions, e.g. transmembrane pressure, and concentration gradients.

A relatively recent advance in this field utilizes mixed matrix composite (MMC) membranes. Such membranes are characterized by a heterogeneous, active fluid separation layer comprising a dispersed phase of discrete particles in a continuous phase of a polymeric material. The dispersed phase particles are microporous materials that have discriminating adsorbent properties for certain size molecules. Chemical compounds of suitable size can selectively migrate through the pores of the dispersed phase particles. In a fluid separation involving a mixed matrix membrane, the dispersed phase material is selected to provide separation characteristics that improve the permeability and/or selectivity performance relative to that of an exclusively continuous phase polymeric material membrane.

U.S. Pat. Nos. 4,740,219, 5,127,925, 4,925,562, 4,925,459, 5,085,676, 6,508,860, 6,626,980, and 6,663,805, which are not admitted to be prior art with respect to the present invention, by their mention in this background, disclose information relevant to mixed matrix composite membranes. U.S. Pat. Nos. 4,705,540, 4,717,393, and 4,880,442, and U.S. Patent Publication Nos. 2004/0147796, 2004/0107830, and 2004/0147796, which are not admitted to be prior art with respect to the present invention by their mention in this background, disclose polymers relevant to permeable fluid separation membranes. However, these references suffer from one or more of the disadvantages discussed herein.

Permselective membranes for fluid separation are used commercially in applications such as the production of oxygen-enriched air, production of nitrogen-enriched-air for inerting and blanketing, separation of carbon dioxide from methane or nitrogen, and the separation of carbon dioxide or hydrogen from various petrochemical and oil refining streams. It is highly desirable to use membranes, such as MMC membranes, that exhibit high permeabilities, and good permselectivities in these applications.

MMC membranes that exhibit high permeabilities, and good permselectivities in some applications have proven problematic to the industry. Some MMC membrane processes uses a suspension slurry containing a high mass ratio of small, dispersed particles making the slurry difficult to process and increasing the brittleness of the membranes. Some MMC processes fail to teach how to prepare hollow fiber membranes using MMC suspensions. Furthermore membranes with an improved balance of high productivity and selectivity, particularly for the fluids of interest discussed above, are needed.

It remains highly desirable to provide a mixed matrix fluid separation membrane having an improved combination of higher flux and selectivity, and have sufficient flexibility to be processed on a commercial basis into a wide variety of membrane configurations, including hollow fiber membranes. It is also desirable that the membrane has sufficient strength to maintain structural integrity despite exposure to high transmembrane pressures. It is particularly desirable to have membranes that provide good selectivity performance for separating oxygen from nitrogen and carbon dioxide from nitrogen or hydrocarbon streams.

### SUMMARY

The present invention provides a method of making a mixed matrix membrane with improved selectivity by using a washed sieve material. Mixed matrix membranes made with washed sieve material demonstrate surprising improvement to membrane permeability and selectivity over membranes made with unwashed sieve material. In particular, membranes of the current invention performed surprisingly well for separating oxygen and nitrogen. Furthermore, film membranes made by the current method performed surprisingly well for separating carbon dioxide and nitrogen. This method of fabricating the mixed matrix hollow fiber membrane is particularly suitable for producing hollow fiber mixed matrix membranes for use in applications such as the production of oxygen-enriched air, production of nitrogen-enriched-air for inerting and blanketing, separating carbon dioxide from certain processes, and the separation of hydrogen from various petrochemical and oil refining streams.

The method of the current invention produces a fluid separation membrane by providing a polymer and a washed molecular sieve material, then synthesizing a concentrated suspension of a solvent, the polymer, and the washed molecular sieve material. The concentrated suspension is then used to form the fluid separation membrane.

Other embodiments:
(a) use SSZ-13 molecular sieve material;
(b) use calcinated SSZ-13 sieve material, silanated SSZ-13 sieve material, sized SSZ-13 sieve material, or mixtures thereof;
(c) add an additive to the membrane spinning suspension to form an electrostabilized suspension;
(d) form a hollow fiber membrane;
(e) use P84 polymer, P84-HT polymer, Ultem 1000 polymer, Matrimid polyimide polymer, or mixtures thereof for the polymer; and
(f) use an annealed P84 polymer.

Membranes are produced that contain a Na—SSZ-13 molecular sieve material, a H—SSZ-13 molecular sieve material, or mixtures thereof. One preferred membrane produced would be a hollow fiber membrane.

This invention also includes a method of separating one or more fluids from a fluid mixture comprising the steps of:
(a) providing a fluid separation membrane produced by the current method;
(b) contacting a fluid mixture with a first side of the fluid separation membrane thereby causing a preferentially permeable fluid of the fluid mixture to permeate the fluid separation membrane faster than a less preferentially permeable fluid to form a permeate fluid mixture enriched in the preferentially permeable fluid on a second side of the fluid separation membrane, and a retentate fluid mixture depleted in the preferentially permeable fluid on the first side of the fluid separation membrane; and
(c) withdrawing the permeate fluid mixture and the retentate fluid mixture separately.

These and other features, aspects, and advantages of the present invention will become better understood with regard to the following description, and appended claims.

### DESCRIPTION

The method of the current invention produces a mixed matrix membrane with surprisingly superior permeability and selectivity performance characteristics by incorporating a washed molecular sieve material. Washed molecular sieve material is commercially available from some molecular sieve material suppliers, such as Chevron Research & Technology Company. A concentrated suspension containing a solvent, a polymer, and the washed molecular sieve material is synthesized. The concentrated suspension is used to form a membrane with surprisingly superior permeability and selectivity performance. Other components can be present in the polymer such as, processing aids, chemical and thermal stabilizers and the like, provided that they do not significantly adversely affect the separation performance of the membrane.

As used in this application, “mixed matrix membrane” or “MMC membrane” refers to a membrane that has a selectively permeable layer that comprises a continuous phase of a polymeric material and discrete particles of adsorbent material uniformly dispersed throughout the continuous phase. These particles are collectively sometimes referred to herein as the “discrete phase” or the “dispersed phase”. Thus the term “mixed matrix” is used here to designate the composite of discrete phase particles dispersed within the continuous phase.

As used in this application, “P84” or “P84HT” refers to polyimide polymers sold under the tradenames P84 and P84HT respectively from HP Polymers GmbH.

As used in this application, “Ultem®” refers to a thermoplastic polyetherimide high heat polymer sold under the trademark Ultem®, designed by General Electric, and available from a number of manufacturers.

As used in this application, “Matrimid®” refers to a line of bismaleides and polyimide polymers sold under the trademark Matrimid® by Huntsman Advanced Materials.

The current invention forms a fluid separation membrane by providing a polymer and a washed molecular sieve material; synthesizing a concentrated suspension comprising a solvent, the polymer, and the washed molecular sieve material, and forming a membrane using the concentrated suspension. Preferred membrane forms include, but are not limited to, hollow fiber membranes.

The continuous phase of the mixed matrix membrane consists essentially of a polymer. By “consists essentially of” is meant that the continuous phase, in addition to polymeric material, may include non-polymer materials that do not materially affect the basic properties of the polymer. For example, the continuous phase can include preferably small proportions of fillers, additives and process aids, such as surfactant residue used to promote dispersion of the molecular sieve in the polymer during fabrication of the membrane.

Preferably, the polymeric continuous phase is nonporous. By “nonporous” it is meant that the continuous phase is substantially free of dispersed cavities or pores through which components of the fluid mixture could migrate. Transmembrane flux of the migrating components through the polymeric continuous phase is driven primarily by molecular solution/diffusion mechanisms. Therefore, it is important that the polymer chosen for the continuous phase is permeable to the components to be separated from the fluid mixture. Preferably, the polymer is selectively fluid permeable to the components, meaning that fluids to be separated from each other permeate the membrane at different rates. That is, a highly permeable fluid will travel through the continuous phase faster than will a less permeable fluid. The selectivity of a fluid permeable polymer is the ratio of the permeabilities of the pure component fluids. Hence, the greater the difference between transmembrane fluxes of individual components, the larger will be the selectivity of a particular polymer.

A diverse variety of polymers can be used for the continuous phase. Typical polymers suitable for the nonporous polymer of the continuous phase according to the invention include substituted or unsubstituted polymers and may be selected from polysiloxane, polycarbonates, silicone-containing polycarbonates, brominated polycarbonates, polysulfones, polyether sulfones, sulfonated polysulfones, sulfonated polyether sulfones, polyimides and aryl polyimides, polyether imides, polyketones, polyether ketones, polyamides including aryl polyamides, poly(esteramide-diisocyanate), polyamide/imides, polyolefins such as polyethylene, polypropylene, polybutylene, poly-4-methyl pentene, polyacetylenes, polytrimethysilylpropyne, fluorinated polymers such as those formed from tetrafluoroethylene and perfluorodioxoles, poly(styrenes), including styrene-containing copolymers such as acrylonitrile-styrene copolymers, styrene-butadiene copolymers and styrene-vinylbenzylhalide copolymers, cellulosic polymers, such as cellulose acetate-butyrate, cellulose propionate, ethyl cellulose, methyl cellulose, cellulose triacetate, and nitrocellulose, polyethers, poly(arylene oxides), such as poly(phenylene oxide) and poly(xylene oxide), polyurethanes, polyesters (including polyarylates), such as poly(ethylene terephthalate), and poly(phenylene terephthalate), poly(alkyl methacrylates), poly(acrylates), polysulfides, polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ketones), poly(vinyl ethers), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates), polyallyls, poly(benzobenzimidazole), polyhydrazides, polyoxadiazoles, polytriazoles: poly(benzimidazole), polycarbodiimides, polyphosphazines, and interpolymers, including block interpolymers containing repeating units from the above such as terpolymers of acrylonitrile-vinyl bromide-sodium salt of para-sulfophenylmethallyl ethers, and grafts and blends containing any of the foregoing. The polymer suitable for use in the continuous phase is intended to also encompass copolymers of two or more monomers utilized to obtain any of the homopolymers or copolymers named above. Typical substituents providing substituted polymers include halogens such as fluorine, chlorine and bromine, hydroxyl groups, lower alkyl groups, lower alkoxy groups, monocyclic aryl, lower acyl groups and the like.

Some preferred polymers for the continuous phase include, but are not limited to, polysiloxane, polycarbonates, silicone-containing polycarbonates, brominated polycarbonates, polysulfones, polyether sulfones, sulfonated polysulfones, sulfonated polyether sulfones, polyimides, polyetherimides, polyketones, polyether ketones, polyamides, polyamide/imides, polyolefins such as poly-4-methyl pentene, polyacetylenes such as polytrimethysilylpropyne, and fluoropolymers including fluorinated polymers and copolymers of fluorinated monomers such as fluorinated olefins and fluorodioxoles, and cellulosic polymers, such as cellulose diacetate and cellulose triacetate. An example of a preferred polyetherimide is Ultem® 1000.

Preferred polyimide polymers include, but are not limited to:
(a) P84 and P84-HT polymers;
(b) Matrimid polyimide polymers;
(c) Type I polyimides and polyimide polymer blends as described in co-pending application 10/642407, titled, “Polyimide Blends for Gas Separation Membranes”, filed Aug. 15, 2003, the entire disclosure of which is hereby incorporated by reference;
(d) polyimide/polyimide-amide and polyimide/polyamide polymer blends as described in co-pending application ______, titled “Novel Separation Membrane Made From Blends of Polyimide With Polyamide or Polyimide-Amide Polymers”, filed Jan. 14, 2005, the entire disclosure of which is hereby incorporated by reference; and
(e) annealed polyimide polymers as described in co-pending application ______, titled, “Improved Separation Membrane by Controlled Annealing of Polyimide Polymers”, filed ______, the entire disclosure of which is hereby incorporated by reference.

Any washed sieve with the desired performance results known to one of ordinary skill in the art may be used in the current invention. One preferred family of molecular sieves that may be supplied in a washed form and used in the mixed matrix membrane of the current invention is described in U.S. Pat. No. 6,626,980, which is fully incorporated herein by this reference. This type of molecular sieve is iso-structural with the mineral zeolite known as chabazite (CHA).

Illustrative examples of CHA type molecular sieves that may be supplied in a washed form and suitable for use in this invention include SSZ-13, H—SSZ-13, Na—SSZ-13, SAPO-34, and SAPO-44. SSZ-13 is an aluminosilicate molecular sieve material prepared as disclosed in U.S. Pat. No.4,544,538, the entire disclosure of which is hereby incorporated by reference. A washed version of SSZ-13 sieve material is commercially available from Chevron Research Company. The description and method of preparation of silicoaluminophosphate molecular sieves SAPO-34 and SAPO-44 are found in U.S. Pat. No. 4,440,871, which, is hereby incorporated herein by reference.

In one embodiment, the washed sieve material is converted to the Na—SSZ-13 form as described by U.S. Pat. No. 4,544,538, the entire disclosure of which is hereby incorporated by reference. Na—SSZ-13 typically contains a Na/Al ratio of greater than about 0.4 as measured by electron spectroscopy chemical application (“ESCA”) analysis or by inductively coupled plasma (“ICP”) analysis.

One embodiment converts the washed sieve material to the H-form (“H—SSZ-13”) with a Na/Al ratio of less than 0.3, even more preferably less than 0.1, by exchanging the Na ions with NH₄ followed by heating at 400-500° C.

Neither XRD nor micropore volume can be used to distinguish between the washed SSZ-13 sample of the current invention and other comparative SSZ-13 samples. However, there is marked difference in the MMC performance of the membranes produced with washed SSZ-13 and comparative samples. Other chemical analysis techniques can be used to distinguish the changes in surface chemistry of the washed SSZ-13 relative to the comparative SSZ-13 samples.

The hydrogen and sodium forms of SSZ-13, referred to herein respectively as H—SSZ-13 and Na—SSZ-13, are two preferred CHA molecular sieves for use in this invention. H—SSZ-13 is formed from calcinated Na—SSZ-13 by hydrogen exchange or preferably by ammonium exchange followed by heating to about 280-400° C., or in some embodiments, heating to 400-500° C. As used in this application, “calcinated SSZ-13”, refers an SSZ-13 sieve material with organic R removed.

In one aspect of this invention, the washed molecular sieve can be bonded to the continuous phase polymer. The bond provides better adhesion and an interface substantially free of gaps between the washed molecular sieve particles and the polymer. Absence of gaps at the interface prevents mobile species migrating through the membrane from bypassing the molecular sieves or the polymer. This assures maximum selectivity and consistent performance among different samples of the same molecular sieve/polymer composition.

Bonding of the washed molecular sieve to the polymer utilizes a suitable binder such as a silane. Any material that effectively bonds the polymer to the surface of the washed molecular sieve should be suitable as a binder provided the material does not block or hinder migrating species from entering or leaving the pores. Preferably, the binder is reactive with both the washed molecular sieve and the polymer. The washed molecular sieve can be pretreated with the binder prior to mixing with the polymer, for example, by contacting the molecular sieve with a solution of a binder dissolved in an appropriate solvent. This step is sometimes referred to as “sizing” the molecular sieve material. Such sizing typically involves heating and holding the molecular sieve dispersed in the binder solution for a duration effective to react the binder with silanol groups on the molecular sieve. Alternatively, the binder can be added to the dispersion of the washed molecular sieve in polymer solution. In such case the binder can be sized to the washed molecular sieve while also reacting the binder to the polymer. Bonding of the washed molecular sieve to the polymer is completed by reacting functional groups of the binder on the sized molecular sieve with the polymer. Thus, as used in this application, “sized SSZ-13” refers an SSZ-13 sieve material that is treated with a binder as described above. Sizing is disclosed in U.S. Pat. No. 6,626,980, the entire disclosure of which is hereby incorporated by reference.

Monofunctional organosilicon compounds disclosed in U.S. Pat. No. 6,508,860, the entire disclosure of which is hereby incorporated by reference, are one group of preferred binders. Representative of such monofunctional organosilicon compounds are 3-aminopropyl dimethylethoxy silane (APDMS), 3-isocyanatopropyl dimethylchlorosilane (ICDMS), 3-aminopropyl diisopropylethoxy silane (ADIPS) and mixtures thereof. Thus, as used in this application, “silanated SSZ-13” refers an SSZ-13 sieve material that is treated as described above with a monofunctional organosilicon compound as a binder.

In another aspect of the invention, the concentrated suspension can be treated with an electrostatically stabilizing additive, referred to herein as an “electrostabilizing additive” to form a stabilized suspension from which the MMC membrane is formed. This electrostabilizing method is disclosed in co-pending U.S. application Ser. No. ______, titled, “Novel Method of Making Mixed Matrix Membranes Using Electrostatically Stabilized Suspensions”, filed the same day as this application, and the entire disclosure of which is hereby incorporated by reference. Thus, as used in this application, “electrostabilized suspension” refers to a concentrated suspension for forming membranes that has been stabilized by the method of the above application.

The mixed matrix membrane of this invention is formed by uniformly dispersing the washed molecular sieve in the continuous phase polymer. This can be accomplished by dissolving the polymer in a suitable solvent and then adding the washed molecular sieve, either directly as dry particulates or as a slurry to the liquid polymer solution to form a concentrated suspension. The slurry medium can be a solvent for the polymer that is either the same or different from that used in polymer solution. If the slurry medium is not a solvent for the polymer, it should be compatible (i.e., miscible) with the polymer solution solvent and it should be added in a sufficiently small amount that will not cause the polymer to precipitate from solution. Agitation and heat may be applied to dissolve the polymer more rapidly or to increase the solubility of the polymer in the solvent. The temperature of the polymer solvent should not be raised so high that the polymer or molecular sieve, are adversely affected. Preferably, solvent temperature during the dissolving step should be about 25-100° C. An electrostabilizing additive may be added to the concentrated suspension while the suspension is agitated to form a stabilized suspension.

The polymer solution should be agitated to maintain a substantially uniform dispersion prior to mixing the slurry with the polymer solution. Agitation called for by this process can employ any conventional high shear rate unit operation such as ultrasonic mixing, ball milling, mechanical stirring with an agitator and recirculating the solution or slurry at high flow through or around a containment vessel.

Various membrane structures can be formed by conventional techniques known to one of ordinary skill in the art. For example, the suspension can be sprayed, cast with a doctor knife, or a substrate can be dipped into the suspension. Typical solvent removal techniques include ventilating the atmosphere above the forming membrane with a diluent gas and drawing a vacuum. Another solvent removal technique calls for immersing the dispersion in a non-solvent for the polymer that is miscible with the solvent of the polymer solution. Optionally, the atmosphere or non-solvent into which the dispersion is immersed, and/or the substrate, can be heated to facilitate removal of the solvent. When the membrane is substantially free of solvent, it can be detached from the substrate to form a self-supporting structure or the membrane can be left in contact with a supportive substrate to form an integral composite assembly. In such a composite, preferably the substrate is porous or permeable to fluid components that the membrane is intended to separate. Further optional fabrication steps include washing the membrane in a bath of an appropriate liquid to extract residual solvent and other foreign matter from the membrane and drying the washed membrane to remove residual liquid.

One preferred embodiment of the current invention forms a mixed matrix hollow fiber membrane for fluid separation comprising an inner bore and an outer surface. Methods of forming hollow fiber membranes are known by one of ordinary skill in the art. One preferred method of making hollow fiber mixed matrix membranes is described in detail in U.S. Pat. No. 6,663,805, the entire disclosure of which is hereby incorporated by reference. The method of U.S. Pat. No. 6,663,805 feeds a spinning suspension through a spinnerette to form hollow fibers comprising a selectively fluid permeable polymer and a solvent for the selectively fluid permeable polymer, and immersing the nascent hollow fiber in a coagulant for a duration effective to solidify the selectively fluid permeable polymer, thereby forming a monolithic mixed matrix hollow fiber membrane.

The ratio of molecular sieve to polymer in the membrane can be within a broad range. Enough continuous phase should be present to maintain the integrity of the mixed matrix composite. For this reason, the polymer usually constitutes at least about 50 weight percent (wt. %) of the molecular sieve plus polymer. It is desirable to maintain the respective concentration of polymer in solution and molecular sieve in suspension at values which render these materials free flowing and manageable for forming the membrane. Preferably, the molecular sieve in the membrane should be about 5 weight parts per hundred weight parts (“pph”) polymer to about 50 pph polymer, and more preferably about 10-30 pph polymer.

The solvent utilized for dissolving the polymer to form the suspension medium and for dispersing the molecular sieve in suspension is chosen primarily for its ability to completely dissolve the polymer and for ease of solvent removal in the membrane formation steps. Additional considerations in the selection of solvent include low toxicity, low corrosive activity, low environmental hazard potential, availability and cost. Common organic solvents, including most amide solvents that are typically used for the formation of polymeric membranes, such as N-methylpyrrolidone (“NMP”), N, N-dimethyl acetamide (“DMAC”), or highly polar solvents such as m-cresol. Representative solvents for use according to this invention also include tetramethylenesulfone (“TMS”), dioxane, toluene, acetone, and mixtures thereof.

One aspect of the invention, is a membrane formed by the method described above wherein the membrane formed comprises a washed molecular sieve material and a polymer. In one embodiment, the washed sieve material is a washed Na—SSZ-1 3 molecular sieve material, a washed H—SSZ-13 molecular sieve material, or a mixture of the washed Na—SSZ-13 and washed H—SSZ-13 molecular sieve materials. In another embodiment of the product, the MMC membrane comprises P84 polymer, P84-HT polymer, Ultem 1000 polymer, Matrimid polyimide polymer, or mixtures of those polymers. In yet another embodiment, the membrane is a hollow fiber membrane.

The current invention includes a method of separating one or more fluids from a fluid mixture comprising the steps of:
(a) providing a fluid separation membrane of the current invention;
(b) contacting a fluid mixture with a first side of the fluid separation membrane thereby causing a preferentially permeable fluid of the fluid mixture to permeate the fluid separation membrane faster than a less preferentially permeable fluid to form a permeate fluid mixture enriched in the preferentially permeable fluid on a second side of the fluid separation membrane, and a retentate fluid mixture depleted in the preferentially permeable fluid on the first side of the fluid separation membrane; and
(c) withdrawing the permeate fluid mixture and the retentate fluid mixture separately.

The novel MMC membranes made by the current method can operate under a wide range of conditions and thus are suitable for use in processing feed streams from a diverse range of sources. For example, one preferred embodiment of the invention produces a hollow fiber membranes that has the mechanical strength to withstand high transmembrane pressures. These high strength hollow fiber membranes can be used for processes where pressure gradient across said membrane is in a range of about 100 to about 2000 psi. One preferred embodiment is used for processes where pressure gradient across said membrane is in a range of about 1000 to about 2000 psi. Due to the good permeability, selectivity, and high strength capabilities of hollow fiber membranes made according to the current invention, one preferred method uses a membrane of the current invention to separate a feedstream that comprises oxygen and nitrogen. Another preferred method separates a feedstream that comprises carbon dioxide and nitrogen.

Membranes made with washed molecular sieve material offer the advantage of surprisingly good combination of higher permeability and selectivity when compared with membranes using non-washed molecular sieve material. The permeability and selectivity of hollow fiber membranes made by the current method are particularly, and surprising good for the separation of oxygen and nitrogen. The permeability and selectivity of film membranes made by the current method are particularly, and surprising good for the separation of carbon dioxide and nitrogen. Membranes produced according to preferred methods also have sufficient strength to maintain structural integrity despite exposure to high transmembrane pressures when made into a hollow fiber form. This invention is particularly useful for separating oxygen or carbon dioxide from process streams, particularly nitrogen, or hydrogen from methane and/or other hydrocarbons mixtures.

### EXAMPLES

This invention is now illustrated by examples of certain representative, non-limiting embodiments thereof.

In the examples herein, an aluminosilicate molecular sieve material used is known as SSZ-13, which is described in U.S. Pat. No. 4,544,538. The Na form of SSZ-13, made from calcinated SSZ-13, with a Na/Al ratio of 0.57 (as measured by ICP) was used in some examples. The examples were silanated with APDMS as described in U.S. Pat. No. 6,508,860. In addition, the H form of SSZ-1 3 was also tested. The H—SSZ-1 3 was produced using calcinated SSZ-13 soaked in aqueous NH₄NO₃, then the exchanged NH₄ was converted to the H form by heating at 400° C. The H—SSZ-13 samples had a Na/Al ratio of <0.1 (as measured by both ICP and ESCA), and were also silanated with APDMS as described in U.S. Pat. No. 6,508,860. The particle sizes of the SSZ-13 samples are summarized in Table 1.

TABLE 1
SSZ-13 Particle Size

| | Ion | |
|---|---|---|
| | Exchange | Particle |
| Sample | Form | Size (μm) |
| A | H | 0.1-0.6 |
| B | H | 2-8 |
| C | Na | 2-8 |
| D | Na | 0.1-0.8 |
| E | H | 0.1-0.8 |

To prepare samples of membranes using washed SSZ-13, a calcined and washed SSZ-13 was obtained. One preferred washed SSZ-13 had a Na/Al ratio of about 0.5 as measured by ICP and a Na/Al ratio of about 0.3 as measured by ESCA. The SSZ-13 was silanated in all cases with APDMS.

### PERMEABILITY OF PVAc MMC FILM EXAMPLES

Polyvinyl acetate (PVAc) film examples were made by dissolving PVAc in toluene to form a 20% (by weight) solution. Molecular sieve material (zeolite) was dispersed in this polymer solution to form a suspension containing 15% bop of the zeolite (wt. of zeolite*100/wt. of polymer=15; bop=based on polymer). Films were cast on a flat Teflon coated surface with a 100 μm knife gap. After the film was formed, residual solvent was evaporated in a vacuum oven at 100° C. Samples of the resulting film were tested in a permeation cell with individual gases at 35° C. and 40-60 psi. Film permeability (“P”) was calculated for all films from measuring the rate of permeating gas, J, through a sample of exposed area A and thickness δ at a pressure differential of Δp:
P=Jδ/(A Δp)

P for all films is expressed in units of Barrers (B) [10⁻¹⁰ cm³ (STP) cm/cm² sec cm (Hg)]. The film selectivity is the ratio of P for two gases.

The fluid permeation performance of comparative examples of PVAc MMC membranes made as described above using non-washed SSZ-13 is shown in Table 2. Examples 1-4 were originally calcinated by the supplier and were subject to a further calcination step at a higher temperature in preparation for the testing. Some samples were also silanated when received and subjected to a further drying step as indicated in the table.

TABLE 2
Permeation Data For MMC PVAc Film Membranes Using
Unwashed SSZ-13

| | | Film | | | |
|---|---|---|---|---|---|
| | | Drying | | | |
| | Zeolite | Temp | Permeability | Selectivity | Selectivity |
| Example # | Preparation | (° C.) | (O₂) | (O₂/N₂) | (CO₂/N₂) |
| 1 | H-SSZ-13 | 75 | 0.94 | 6.43-6.87 | — |
| | Further | | | | |
| | Calcined | | | | |
| | 400° C. | | | | |
| | Silanation | | | | |
| | drying | | | | |
| | 120° C. | | | | |
| | Further | | | | |
| | drying | | | | |
| | 195 C. | | | | |
| 2 | ″ | 75 | 0.93 | 6.48-6.93 | — |
| | Example 1 | | | | |
| 3 | H-SSZ-13 | 75 | 0.67 | 6.22 | — |
| | Further | | | | |
| | Calcined | | | | |
| | 590° C. | | | | |
| | Silanation | | | | |
| | drying | | | | |
| | 120° C. | | | | |
| | Further | | | | |
| | drying | | | | |
| | 195 C. | | | | |
| 4 | ″ | 75 | 0.69 | 6.36 | — |
| | Example 3 | | | | |
| 5 | H-SSZ-13 | 75 | 0.76 | 6.34 | — |
| | Calcined | | | | |
| | 400° C. | | | | |
| | Silanation | | | | |
| | drying | | | | |
| | 135° C. | | | | |
| 6 | ″ | 75 | 0.69 | 6.33 | — |
| | Example 5 | | | | |
| 7 | H-SSZ-13, | 135 | 0.69 | 6.53 | 44.2 |
| | Calcined | | | | |
| | 400° C., | | | | |
| | Silanation | | | | |
| | drying | | | | |
| | 135° C. | | | | |
| 8 | H-SSZ-13 | 75 | 0.57 | 6.63 | 46.9 |
| | Calcined | | | | |
| | 400° C. | | | | |
| | Silanation | | | | |
| | drying | | | | |
| | 135° C. | | | | |
| | Further | | | | |
| | drying at | | | | |
| | 180° C. | | | | |
| 9 | ″ | 75 | 0.59 | 6.26 | 42.9 |
| | Example 8 | | | | |
| 10 | H-SSZ-13 | 75 | 0.57 | 6.63 | 46.9 |
| | Calcined | | | | |
| | 400° C. | | | | |
| | Silanation | | | | |
| | drying | | | | |
| | 135° C. | | | | |
| 11 | ″ | 75 | 0.59 | 6.26 | 42.9 |
| | Example 10 | | | | |
| 12 | H-SSZ-13 | 75 | 0.59 | 6.83 | 44.2 |
| | Calcined | | | | |
| | 400° C. | | | | |
| | Silanation | | | | |
| | drying | | | | |
| | 135° C. | | | | |
| | Further | | | | |
| | dried at | | | | |
| | 180° C. | | | | |
| Avg. | | | 0.69 | 6.48 | 44.7 |

The fluid permeation performance of test examples of PVAc MMC membranes made as described above using washed SSZ-13 is shown in Table 3. Samples of the resulting film were tested in a permeation cell with individual gases at 35° C. and 40-60 psi. All samples used calcinated and washed SSZ-13 that was silanated with APDMS.

TABLE 3
Permeation Data For MMC PVAc Film
Membranes Using Washed SSZ-13

| Exam- | Permeability | Permeability | Selectivity | Selectivity | Selectivity |
|---|---|---|---|---|---|
| ple # | (O₂) | (CO₂) | (O₂/N₂) | (CO₂/N₂) | (He/N₂) |
| 13 | 0.6 | 4.0 | 6.7 | 44 | |
| 14 | 0.64 | 4.4 | 6.7 | 43 | |
| 15 | 0.64 | 3.8 | 7.5 | 44 | 203 |
| 16 | 0.62 | 4.0 | 7.1 | 46 | 209 |
| Avg. | 0.63 | 4.1 | 7.0 | 44 | 206 |

Comparing the data of Tables 2 and 3, as was expected, there was little difference in the performance of the non-washed SSZ-13 and washed SSZ-13 when used to produce a film-type membrane using a matrix of PVAc polymer.

### PERMEABILITY OF ULTEM MMC FILM EXAMPLES

Ultem film examples were made by dispersing SSZ-13 in a solution of a 25% Ultem 1000 in N-methyl pyrollidone (NMP). The 15% bop zeolite suspension was cast on a glass plate and then heated overnight at 150° C. The film was redissolved in NMP to form a suspension of zeolite dispersed in an approximately 20% polymer solution, and recast as a dense film on a glass plate heated to 65° C. After the film was formed, residual solvent was removed by placing the film with a slight tension in a vacuum oven at 150° C. Samples were tested in a permeation cell with individual gases at 35° C. and 40-60 psi. Washed samples used calcined and washed SSZ-13. The permeation performance of a reference sample and the washed SSZ-13 in Ultem based MMC films are shown in Table 4.

TABLE 4
Permeation Data For MMC UItem Film Membranes

| Exam- | Treatment | Permeability | Permeability | Selectivity | Selectivity |
|---|---|---|---|---|---|
| ple | of SSZ-13 | (O₂) | (CO₂) | (O₂/N₂) | (CO₂/N₂) |
| 17 | Not | 0.4 | 1.4 | 7.6 | 26 |
| | Washed | | | | |
| 18 | Washed | 0.47 | 1.74 | 8.5 | 31 |
| 19 | Washed | 0.45 | 1.58 | 9.2 | 32 |
| 20 | Washed | 0.55 | 1.76 | 9.5 | 30 |
| 21 | Washed | 0.61 | 2.09 | 8.3 | 28 |
| | Avg. of | 0.52 | 1.79 | 8.9 | 31 |
| | Washed | | | | |
| | Samples | | | | |

Comparing the data of Table 4, the sample membranes produced using washed sieve material surprisingly gave significantly improved performance over the non-washed sample when used in an Ultem matrix. Permeability performance of membranes using the washed molecular sieve material improved by over about 30% of those made using un-washed sieve material, and selectivity improved by about 20%.

Hollow fiber examples were made by preparing a MMC solution dope using washed SSZ-13 with a particle size of approximately 0.1 μm. The zeolite was silanated with APDMS in a 95:5 EtOH:water medium and then “sized” in a reaction flask with Ultem 1010 as described in U.S. Pat. No. 6,508,860. The solution procedure consisted of the rapid mixing of pre-made Ultem solution to a sonicated zeolite slurry, followed by additional powdered polymer to bring the dope concentration up to the desired value as quickly as possible. The final dope composition (A) was 32 % Ultem, 15% bop sized SSZ-13, 30% bop TMS in NMP. This dope A was spun as the sheath layer of a composite fiber as described in U.S. Pat. Nos. 5,085,676 and 5,141,46, which describe methods for producing composite hollow fibers in the absence of molecular sieve particles. For the mixed matrix composite fibers of this example, the asymmetric sheath separating layer contains dispersed molecular sieve particles, but the spinneret design and the process for producing composite hollow fibers are essentially the same as in absence of the molecular sieve particles. Typical spinning parameters for producing hollow fibers from Ultem polymers are as follows:
Spin Temperature: 89-96° C.
Bath Temperature: 8-25° C.
Gap: 1-2.5 cm
Wind Up Speed: 25-80 m/min

The results of O₂/N₂ and CO₂/CH₄ permeation testing of conventional fiber membranes produced with un-washed sieve material samples are listed in this Table 5.

TABLE 5
Permeation Data For Ultem Hollow Fiber
Membranes (Not Mixed Matrix)

| | |
|---|---|
| O₂/N₂ 50-100 psi | CO₂/CH₄ 100 psi - 50° C. |

| Sample | O₂ GPU | O₂/N₂ | CO₂ GPU | CO₂/CH₄ |
|---|---|---|---|---|
| 36-16 | — | — | 34 | 34.3 |
| 36-17 | 4.8 | 9.1 | — | — |
| 36-19 | 4.5 | 9.9 | 30.1 | 32.5 |
| 36-20 | 4.3 | 9.0 | — | — |
| 36-33 | 4.2 | 9.3 | 33.6 | 32.7 |
| 36-34 | 4.7 | 9.1 | 37.1 | 33.3 |
| 36-35 | 4.6 | 8.5 | 34.4 | 30.4 |
| 36-40 | — | — | 47.1 | 34.5 |
| 36-42 | 5.7 | 9.0 | 45.5 | 33.1 |
| 36-46 | 5.0 | 9.1 | — | — |
| 36-48 | 4.3 | 10.7 | 51.6 | 33.3 |
| Avg. | 4.7 | 9.3 | 39.2 | 33.0 |

A GPU is a Gas Permeation Unit
1 GPU = 1 × 10⁻⁶ cm³ (STP)/(cm² s cmHg)

For comparison, MMC hollow fibers were produced using unwashed SSZ-13 sieve material dispersed in Ultem polymer. Permeation testing showed that the increase in MMC selectivity using unwashed sieve material was marginal, averaging only about 5% above the data of Table 5.

When washed SSZ-13 sieve material prepared as described above was dispersed in Ultem polymer and used to produce MMC hollow fiber membranes, permeation performance for the oxygen/nitrogen separation showed a significant and surprising improvement over the performance of the standard membrane shown in Table 5 and the average results of non-washed MMC membranes of Ultem polymer. Testing of the Ultem MMC hollow fiber membranes using washed SSZ-13 (tested under the same conditions as sown in Table 5) gave the following permeation results:
O₂ Permeability: 6.7 GPU
O₂/N₂ Selectivity: 8.2
CO₂ Permeability: 28.2 GPU
CO₂/CH₄ Selectivity: 28.8

Clearly, the washed SSZ-13 sieve material gave surprising and significant improvements in the oxygen separation performance of hollow fiber membranes. The oxygen permeability for the MMC membrane using a washed sieve material increased 42% over the non-MMC membrane, whereas the increase was only about 5% when non-washed sieve material was used.

Although the present invention has been described in considerable detail with reference to certain preferred versions and examples thereof, other versions are possible. For instance, film or hollow fiber membranes can be produced. In addition, although SSZ-13 sieve material was the subject of the example, any suitable sieve material may be substituted in the method. Furthermore, a wide variety of polymers may be used with the current invention. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

1. A method of producing a fluid separation membrane, said method comprising the steps of:
(a) providing a polymer and a washed molecular sieve material;
(b) synthesizing a concentrated suspension of a solvent, said polymer, and said washed molecular sieve material; and
(c) forming a membrane.

2. The method of claim 1, wherein said washed molecular sieve material is a washed SSZ-13 molecular sieve material.

3. The method of claim 7, wherein said washed SSZ-13 sieve material is selected from the group consisting of a calcinated SSZ-13 sieve material, a silanated SSZ-13 sieve material, a sized SSZ-13 sieve material, and mixtures thereof.

4. The method of claim 8, wherein said polymer is selected from the group consisting of P84 polymer, P84-HT polymer, Ultem 1000 polymer, Matrimid polyimide polymer, and mixtures thereof.

5. The method of claim 4, further comprising a step of adding an additive to said concentrated suspension to form an electrostabilized suspension.

6. The method of claim 5, wherein said membrane formed is a hollow fiber membrane.

7. The method of claim 6, wherein said polymer is an annealed P84 polymer.

8. A membrane for fluid separation, wherein said membrane comprises a polymer and a washed molecular sieve material.

9. The membrane of claim 8, wherein said washed sieve material is selected from the group consisting of a washed Na—SSZ-13 molecular sieve material, a washed H—SSZ-13 molecular sieve material, and mixtures thereof.

10. The membrane of claim 8, wherein said polymer is selected from the group consisting of P84 polymer, P84-HT polymer, Ultem 1000 polymer, Matrimid polyimide polymer, and mixtures thereof.

11. The membrane of claim 8, wherein said membrane is a hollow fiber membrane.

12. A method of separating a fluid from a fluid mixture comprising the steps of:
(a) providing a hollow fiber membrane produced by the method of claim 1;
(b) contacting a fluid mixture with a first side of said membrane thereby causing a preferentially permeable fluid of said fluid mixture to permeate said membrane faster than a less preferentially permeable fluid to form a permeate fluid mixture enriched in said preferentially permeable fluid on a second side of said membrane and a retentate fluid mixture depleted in said preferentially permeable fluid on said first side of said membrane; and
(c) withdrawing said permeate fluid mixture and said retentate fluid mixture separately,
wherein the pressure gradient across said membrane is in a range of about 100 to about 2000 psi.

13. The method of claim 12, wherein said fluid mixture comprises oxygen and nitrogen.

14. The method of claim 12, wherein said fluid mixture comprises carbon dioxide.

15. The method of claim 12, wherein said pressure gradient across said membrane is in the range of about 1000 to about 2000 psi.
